(19) United States
(12) Patent Application Publication
(10) Pub. No.: US 2010/0318407 A1
(43) Pub. Date: Dec. 16, 2010

(54) Personalized Coupon System

(76) Inventors: Adam Leff, Newbury Park, CA (US); David Bay, Oak Park, CA (US)

Correspondence Address: SoCAL IP LAW GROUP LLP, 310 N. WESTLAKE BLVD. STE 120, WESTLAKE VILLAGE, CA, 91362, US

(21) Appl. No.: 12/815,351

(22) Filed: Jun. 14, 2010

Related U.S. Application Data
(60) Provisional application No. 61/187,237, filed on Jun. 15, 2009.

(51) Int. Cl. G06Q 30/00; G06Q 10/00; G06F 15/16; G06F 17/00

(52) U.S. Cl. 705/10; 705/14.13; 705/14.25; 709/206; 235/375; 235/494

(57) ABSTRACT

A personalized coupon system is disclosed. A localized offer list may be provided to a consumer including a plurality of offers from merchants in a location near the location of the consumer. The offers included in the offer list may be selected by the system based on progressive and regressive rules. When offers are redeemed, the system receives notification of offer redemption. The offer list and personalized electronic communications to the consumer may include offers based on prior activities of the consumer which are tracked by the system. The offer list and personalized electronic communications may include offers based on the activities of other consumers having similar geography and/or demographic information to the consumer. The activities may include viewing, selecting, obtaining, printing and redeeming offers from merchants. Behavior tracking information, maps and graphics may be provided to merchants so that they may understand the success of offers.

### RELATED APPLICATION INFORMATION

This patent claims priority from provisional patent application No. 61/187,237 filed Jun. 15, 2009 which is incorporated by reference herein in its entirety.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

1. Field

This disclosure relates to coupons and more particularly to an electronic delivery based system that delivers or provides personalized offers to a consumer.

2. Description of the Related Art

Coupons are a well known effective marketing and promotion tool. Coupons may be used to direct consumers to products and services with which they are unfamiliar. Coupons may be used to increase the frequency of patronage. By offering a discount on products or services, merchants and service providers hope to introduce consumers to their products and services to initiate an ongoing relationship that will translate into an ongoing revenue stream. Historically, coupons have been delivered by mail and presented in or with newspapers and magazines. In addition, regional or local coupons for merchants and service providers are provided in books that are often used as fundraisers. With the popularity of the Internet, coupons may be found, downloaded and printed from web sites.

### DESCRIPTION OF THE DRAWINGS

The file of this patent contains at least one drawing executed in color. Copies of this patent with color drawings will be provided by the Patent and Trademark Office upon request and payment of the necessary fee.

FIG. 1 is a block diagram of an environment in which the personalized coupon system described herein may be implemented.

FIG. 2 is a flow chart of actions taken to provide personalized coupons

FIG. 3 is a screen shot of a portion of an email note that provides links to a web site that provides personalized coupons.

FIG. 4 is a screen shot of a portion of a web page that provides links to personalized coupons based on categories.

FIG. 5 is a screen shot of a portion of a web page that provides links to personalized coupons based on a selected category.

FIG. 6 is a screen shot of a portion of a web page that provides personalized coupons based on a selected merchant.

FIG. 7 is a screen shot of a window that includes a printable coupon.

FIG. 8 is a screen shot of a first portion of a web page that includes a merchant data entry screen.

FIG. 9 is a screen shot of a second portion of a web page that includes a merchant data entry screen.

FIG. 10 is a screen shot of a portion of a web page that includes an offer data entry screen.

FIG. 11 is a screen shot of a portion of a web page that includes an offer layout specification screen.

FIG. 12 is a screen shot of a portion of a web page that includes a user history of offers printed.

FIG. 13 is a screen shot of a portion of a web page that includes geographical location information and a graph showing coupon users for a merchant.

FIG. 14 is a screen shot of a portion of a web page that includes an offer tracking map.

Throughout this description, elements appearing in figures are assigned three-digit reference designators, where the most significant digit is the figure number and the two least significant digits are specific to the element. An element that is not described in conjunction with a figure may be presumed to have the same characteristics and function as a previously-described element having a reference designator with the same least significant digits.

### DETAILED DESCRIPTION

Personalized coupons may be provided by a personalized coupon system described herein. The personalized coupon system enables advertising and participating service providers, merchants and retailers the ability to provide personalized and/or customized offers to individuals, namely consumers and prospective customers, based on a variety of consumer behaviors as well as the geographic location of the consumer. The term merchant advertiser is used herein to refer to service providers, retailers, and merchants that participate in the personalized coupon system described herein. The personalized coupon system may include a participant or consumer loyalty component, a specialized offer optimization component, an email generation component, a behavior mapping and reporting component, and a personalization integration component, each of which are described herein.

Environment and Hardware

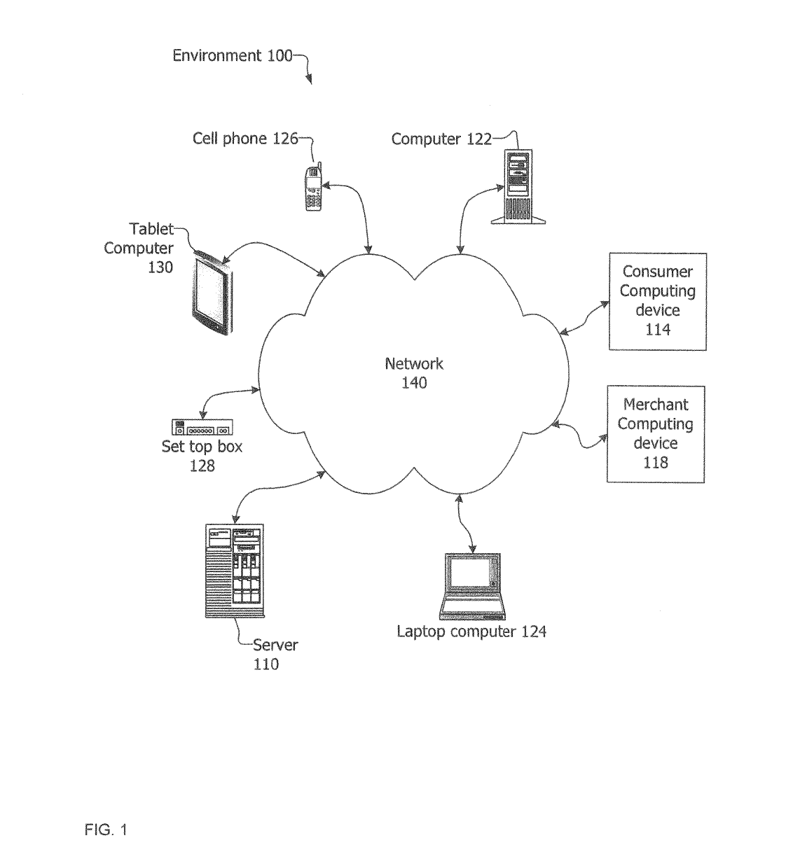

FIG. 1 is a block diagram of an environment in which the personalized coupon system described herein may be implemented. The actions described below as being performed by components of the personalized coupon system may be implemented as software on one or more servers 110 that are accessed over a network 140 by, on the one hand, merchants via merchant computing devices 118, and, on the other hand, consumers and prospective customers of those merchants via consumer computing devices 114. Merchants and consumers may use an Internet browser or other application (including a cellular telephone application), widget, gadget or applet operating on a computing device shown in environment 100 to access the services provided by the servers 110 according to the systems described herein. The network 140 may be wired or wireless or a combination of both. The network 140 may be circuit-switched or packet-switched or a combination of both. The network 140 may be or include the Internet.

The software on the server 110 may be in the form of one of or one or more of each of firmware, application programs, applets (e.g., a Java applet), browser plug-ins, COM objects, dynamic linked libraries (DLLs), scripts, subroutines, operating system components or services, databases and others. The software and its functions may be distributed such that some actions are performed by a first server and others by other servers. The server may run an operating system, including, for example, variations of the Linux, Unix and Microsoft Windows operating systems.

The software may be stored in electronic, machine readable media which may be referred to as storage media. Storage media include, for example, magnetic media such as hard disks, floppy disks and tape; optical media such as compact disks (CD-ROM and CD-RW), digital versatile disks (DVD and DVD±RW), and Blu-ray discs (BD-ROM); flash memory cards, silicon storage devices including solid-state drive (SSDs) and other silicon based storage media; and other storage media. As used herein, a storage device is a device that allows for reading and/or writing to a storage medium. Storage devices include, hard disk drives, DVD drives, flash memory devices, and others.

Computing devices such as the consumer computing devices 114 and the merchant computing devices 118 may be and include personal computers 122, notebook computers, laptop computers 124, cellular telephones 126, personal digital assistants (PDAs), computing tablets 130, set top boxes 128, video game systems, personal video recorders, personal media players, and other devices capable of network communications and running an Internet browser. Internet browsers include for example, versions of Microsoft Internet Explorer, Mozilla Firefox, Skyfire, Apple Safari, and Opera. The computing devices may run an operating system, including, for example, variations of the Linux, Microsoft Windows, Symbian, Chrome, Android, and Apple Mac operating systems. Consumer and merchant computing devices may also include an email program or client such as, for example, Microsoft Outlook and Thunderbird. Consumer and merchant computing devices may also include a text messaging program, client, widget, gadget or applet including a short message service (SMS) program, Yahoo Messenger, etc. Merchants and consumers may use an Internet browser or other application (including a cellular telephone application), widget, gadget or applet operating on a computing device to access the services provided by personalized coupon system described herein.

The consumer's computing devices may be located and accessed at a consumer's home or office, and may be portable and accessed while a consumer is travelling or at a location other than a home or office. The merchant's and retailer's computing devices may be accessed from the merchant's or retailer's place of business or other location.

Processes

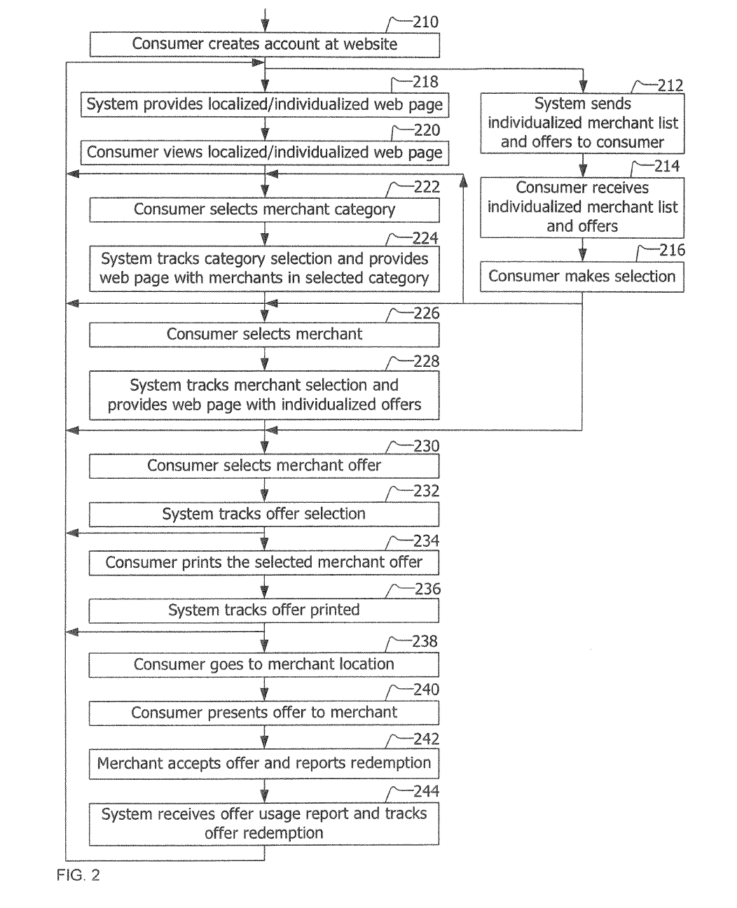

FIG. 2 is a flow chart of actions taken to provide personalized coupons. The actions are implemented by a system running specialized software that interacts with a consumer visitor to the system's web site or a consumer accessing an email note or personalized electronic message sent by the system. A consumer creates account at web site as shown in block 210. This may be referred to as registration. The account creation includes providing name and contact information such as home address, work address, mobile phone number, email address and instant messaging account name. This may be achieved through various graphical user interface constructs such as, for example, text entry fields. A consumer may also access the personalized coupon system, but certain features may not be made available to a consumer who uses the personalized coupon system without registering. When a consumer registers with the personalized coupon system, the personalized coupon system creates a consumer ID to uniquely identify the consumer. The personalized coupon system uses the consumer ID to store information about the consumer and to track and store actions of the consumer. The Consumer ID may be a unique combination of alphanumeric characters, that may include or be one or more of an IP address, a phone number, a street address, a random string or number, or other unique combination of alphanumeric characters. When a consumer visits the personalized coupon system web site without registering, a consumer ID may be created to uniquely identify the consumer. In this situation, the Consumer ID may be a unique combination of alphanumeric characters, that may include or be an IP address, a time representation, a random string or number, or other unique combination of alphanumeric characters. This consumer may be referred to as an anonymous consumer.

A consumer may visit the system web site and perform various actions to obtain personalized coupons. The system provides an entry or initial localized web page that includes merchant categories of merchant advertisers located in or serving a geographic region near to where the consumer is located, as shown in block 218. The initial localized web page is prepared based on location information for the consumer. The personalized coupon system may use the consumer information obtained during registration (in block 210) to prepare and provide an initial localized web page customized to the user's geographic location.

In another embodiment, consumers may visit the personalized coupon system web site without creating an account or registering. Consumers who visit the personalized coupon system web site without creating an account or registering are referred to herein as anonymous consumers. For anonymous users, the personalized coupon system may use the consumer's IP address to determine the consumer's location. For anonymous users, the personalized coupon system may determine the consumer's location by receiving user input such as the name of a city entered into a text entry field on a web page, receiving user selection of a town, city or region from a system provided pull down menu, or through another user interface technique. In these ways, the system may provide anonymous consumers an initial localized web page based on a consumer entered or system determined location. In one embodiment, the IP address of a consumer may be associated with a user's selection or designation of a town city or region, and a the system may create a unique identifier for the anonymous user so that the features of the personalized coupon system may be provided to anonymous users. In a related embodiment, the system may associate tracking information stored for an anonymous consumer with a consumer when the consumer registers with the personalized coupon system according to the IP address of the anonymous now registered consumer.

In other embodiments or when the consumer's location cannot be determined, a national start page may be provided to the consumer. The national start page may provide a United States map and/or listing of all states and/or a list of major cities and/or a list of areas where merchant advertisers are located or where merchant advertisers serve. The system may receive consumer input by mouse click, finger tap or other consumer selection action of a particular state, region or city. The system may also provide a text entry field to receive a consumer's specification of a city or other geographic area. The system may provide a single web page or a series of web pages beginning with a national start page that allows a user to eventually specify a city or region that the system may use to prepare and present an initial localized web page.

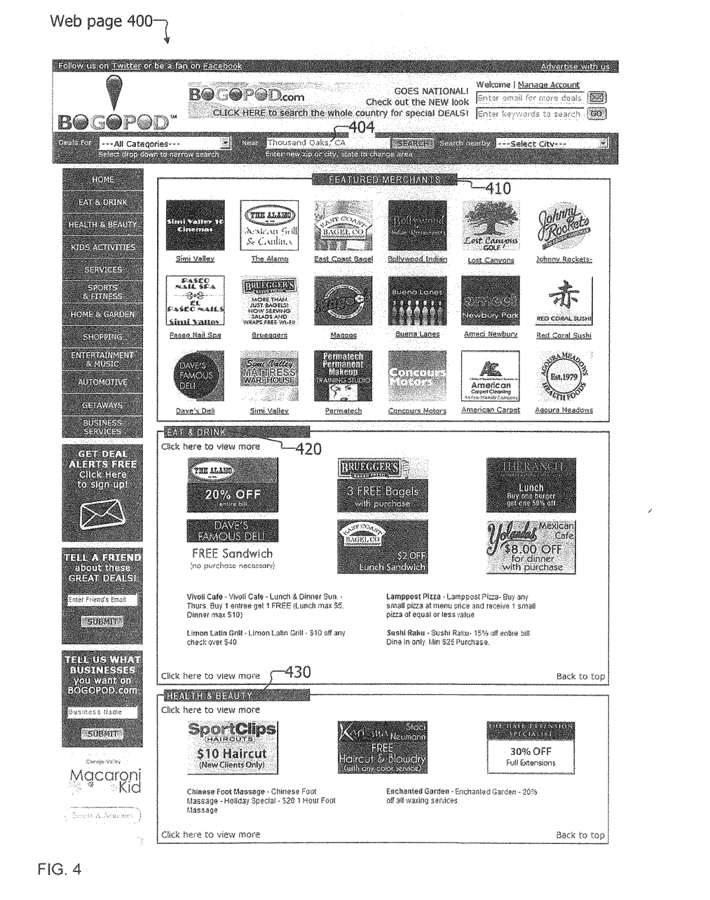

In summary, the initial localized page provides a list or other grouping of geographically close merchants based on specific user input designating a town, city or region, recognizing the consumer's IP address, or obtaining the consumer's zip code or phone number from the consumer's account or cookie information stored through the consumer's Internet browser. FIG. 4 is a screen shot of a portion of an example personalized coupon system initial localized web page 400 that provides links to personalized coupons based on categories and the consumer specified or system identified local area 404. The web page 400 includes merchants and/or coupons from the specified or identified local area 404 arranged by categories such as “featured merchants” 410, “eat & drink” 420, “health & beauty” 430, and others. Example merchant categories include home, dining, food, health, beauty, kids, music, entertainment, leisure, home improvement, shopping, services, automotive, pets, professional, local interest, and others. The system may provide some or all of these on the initial web page.

The consumer views the initial web page, as shown in block 220. The consumer may select a merchant category, as shown in block 222. This selection may be made by clicking on, tapping, or otherwise activating a link associated with the graphical representation or other representation of the merchant category. This selection and other consumer selections made and described regarding FIG. 2 may be made in this same way.

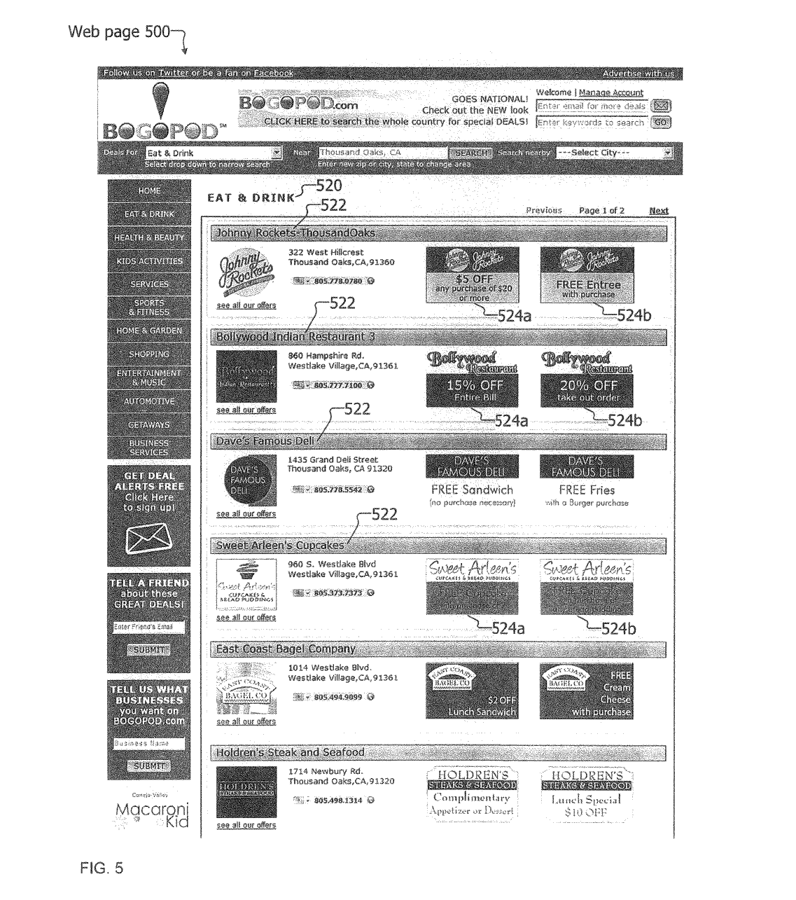

In response, the system tracks the user's category selection and provides a web page with merchants in the selected category, as shown in block 224. FIG. 5 is a screen shot of a portion of a web page 500 that provides links to personalized coupons 524a and 524b from various merchant advertisers 522 based on a selected category 520 and consumer specified or system identified local area (see, for example, 404 “Thousand Oaks, Calif.” in FIG. 4). In this example, the consumer selected “eat & drink” 420 from the web page 400 shown in FIG. 4 and is provided with a list of merchants 522 that provide food and/or drink and related coupon offers from multiple merchant advertisers 522 under heading “eat & drink” 520 in web page 500 shown in FIG. 5.

Returning to a discussion of FIG. 2, the consumer may select a merchant, as shown in block 226. In response, the system tracks the consumer's merchant advertiser selection and provides a web page with individualized offers from the selected merchant advertiser, as shown in block 228. The individualized offers provided by the system may be chosen by the system based one or more factors including, demographic information about the consumer, geographic information about the user, offer using history of the user, offer viewing history of the consumer, and other factors. The other factors may include information about the actions of similarly situated consumers, such as information about consumers with one or more of similar demographic, similar geographic and/or similar personalized coupon system usage history, and other similarities. For example, the personalized coupon system may compute that if women aged 40-45 in a particular zip code who used a coupon from a first restaurant often use a coupon at a second restaurant, when a similar consumer visits the first restaurant, the system may process this information and subsequently prominently display the second restaurant to the consumer on the personalized coupon system web site.

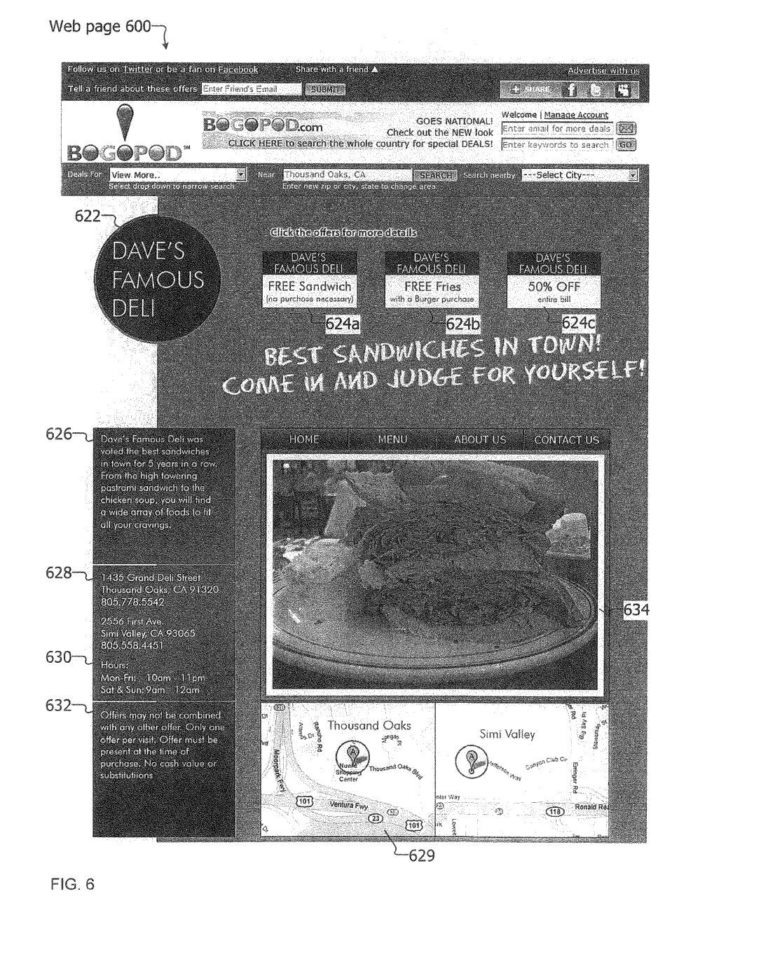

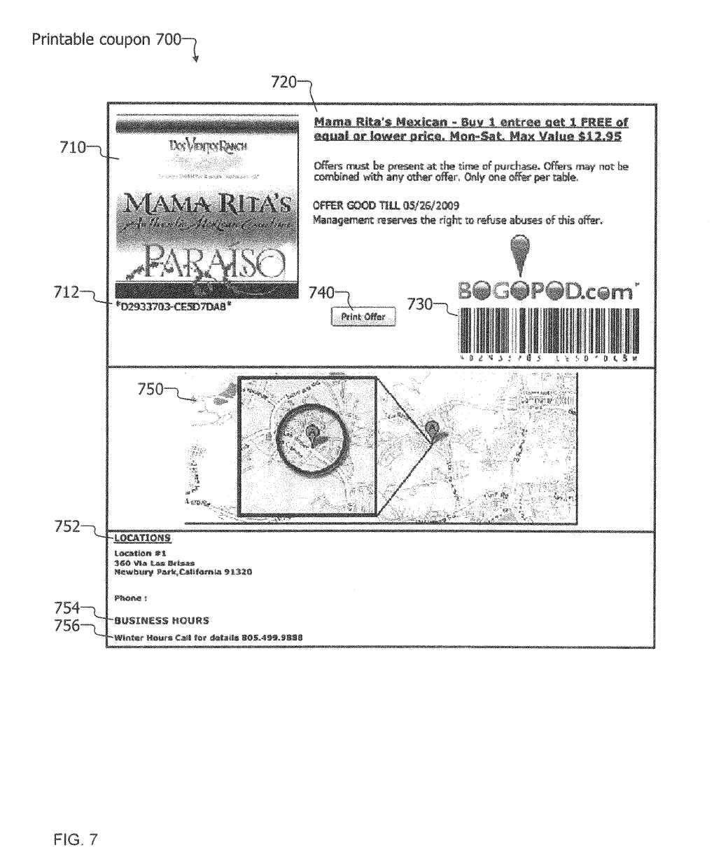

FIG. 6 is a screen shot of a portion of a web page 600 that provides personalized coupons based on a merchant selection made in block 228 of FIG. 2 from the merchants 522 listed in web page 500 in FIG. 5. The web page 600 includes the name of the merchant 622, one or more coupon offers 624a, 624b and 624c, and the merchant's locations in text 628 and, optionally, on maps 629, and merchant contact information 628. The web page may also include a region or area served by the merchant advertiser. The coupon offers may be presented as text and/or graphics linked to a printable, storable or sendable coupon. An example printable coupon 700 is shown and described below regarding FIG. 7. The web page 600 may also include a text description 626 of the merchant, hours of operation of the merchant 630, payment methods accepted, special terms for the offers 632, additional graphics or images 634, and other information about the merchant, the merchant's products or services.

Returning to a discussion of FIG. 2, the consumer may select one of the merchant offers, as shown in block 230. In response, the system tracks the user's offer selection, as shown in block 232. The consumer may print or otherwise obtain the selected merchant offer, as shown in block 234. In response, the system tracks that the user printed or obtained the selected offer, as shown in block 236. The consumer goes to the merchant location and presents the offer to the merchant, as shown in blocks 238 and 240. The merchant advertiser accepts the offer and reports offer redemption, as shown in block 242. The merchant advertiser may report offer redemption, and the system may receive the usage report in a variety of ways, including, the merchant saving the printed offer and an operator of the system picking up the used printed offers from a collection box; the merchant mailing the used printed offers to the system operator; the merchant advertiser scanning and emailing redeemed printed offers; the merchant scanning in a bar code, a two dimensional bar code such as a Quick Response (QR) code, an High Capacity Color Barcode (HCCB) or other tracking code from the used offer and emailing, messaging or uploading the code to the system operator from the merchants computer, mobile phone, or other mobile device. The reporting may be done in batches, such as, for example, every close of business or at a set time, or individually. The system receives the offer usage report and tracks the offer redemption, as shown in block 244.

The flow of actions then returns to block 218 where the system provides an updated localized and individualized web page to the consumer based on one or more of the activities performed by the consumer and tracked by the system, the activities of geographically similar consumers, and the activities of demographically similar consumers.

Although the actions in FIG. 2 are described as operating on web pages such as those shown in FIGS. 4, 5 and 6, the list of merchants and list of offers shown in web pages in FIGS. 4, 5 and 6, as well as the printable coupon shown in FIG. 7, may be provided in windows, panes, frames, application windows, text boxes, or other text and/or image presenting user interface element, application, applet or program on a display of a computing device, such as a display of a personal computer, a display of a cellular telephone, a display of a portable tablet, display of a notebook computer.

In another embodiment, the user may navigate the personalized coupon web site from a portable computing device such as, for example, a mobile phone, laptop computer or computing tablet. As such, steps 210, 220, 222, 226, and 230 may all be performed on or via a portable computing device. In this embodiment, rather than printing an offer as in block 234, the consumer may obtain the selected merchant offer in a variety of ways. The selected merchant offer may be downloaded on, stored on, emailed to or messaged to the user's phone or other portable computing device as a code (for example, bar code, QR code, or other code), file or document (such as an image file or PDF file) presentable on the consumer's mobile device to the merchant when the user visits the merchant as shown in block 240. When the merchant advertiser accepts the offer and reports use of the offer, as shown in block 242, in this embodiment, the merchant advertiser may achieve this reporting using a scanner (handheld or desktop), mobile phone or other portable computing device. The merchant or consumer may use the consumer's device to report the redemption by tapping a “redeem” link or button, moving a slider, or replying to a SMS text message or email note with a merchant provided redemption code. In this fashion the redemption notification provides near immediate notification via Network 140 to the personalization coupon system which in turn allows for near immediate tracking and reporting or the redemption.

After a consumer registers with the personalized coupon system web site as shown in block 210, the system may send an individualized merchant list and individualized offers to the consumer, as shown in block 212. These may be sent as and referred to as a personalized electronic message. The merchants included in the individualized list and the offers included in the individualized offers sent by the system may be chosen by the system based on one or more factors including: demographic information about the consumer, geographic information about the consumer, offer using history of the consumer, offer viewing history of the consumer, and other factors. The other factors may include information about the actions of similarly situated consumers, such as information about consumers with one or more of similar demographic, similar geographic and/or similar personalized coupon system usage history, and other similarities. For example, if men aged 40-45 in a particular zip code who redeemed a coupon from a first store often use a coupon at a second store, when a similar consumer visits the first store, the system may process this information and subsequently provide a coupon to the second store to the consumer and may include the second store in the list of merchants. The sending may be achieved by email, and the email note may contain one or more links to the personalized coupon system web site. In other embodiments, traditional mailing of an offer and SMS text, and electronic messaging systems may be used to deliver the offer or offers to the consumer as a personalized electronic message.

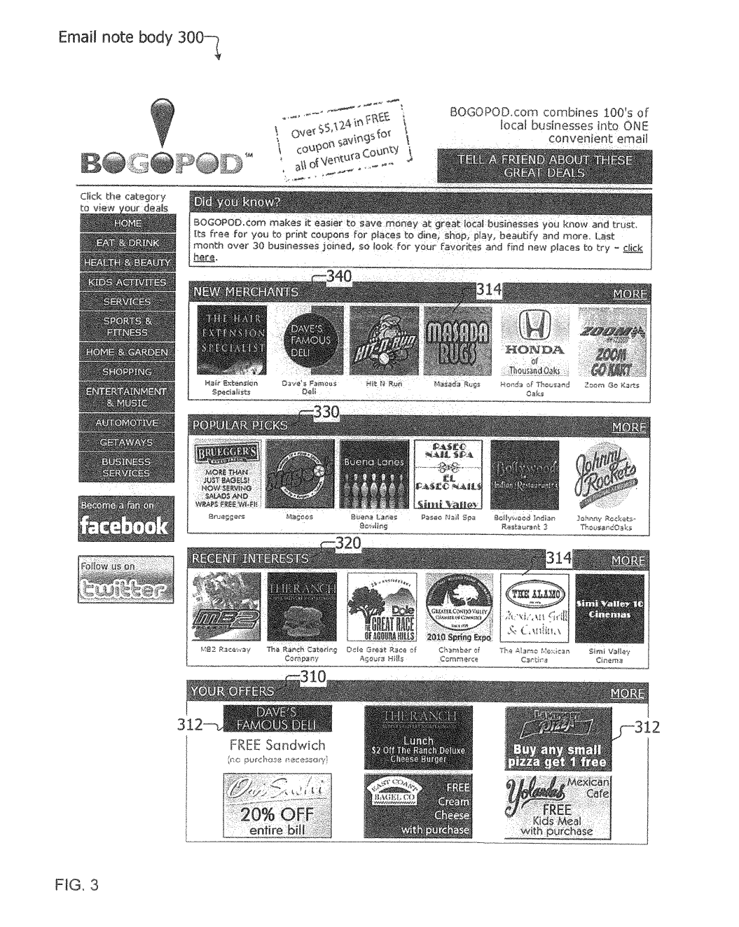

FIG. 3 is a screen shot of a portion of the body an email note 300 that provides links to merchants and offers available at the personalized coupon system web site. The email note may be HTML based with mail headers such as to, from, and date, and footers such as a signature block containing identifying and contact information of the coupon system provider, not shown. The contents of the email note body 300 include links to various personalized offers 312 which may be set off under a heading such as “your offers” 310. The contents of the email note body 300 include links to various personalized merchant advertisers 314 under headings such as “recent interests” 320, “popular picks” 330 and “new merchants” 340. These headings are provided as examples, other heading or no headings may be used in the email note body. The email note may include personalized offers, personalized merchant list, both or either. The email note may include a single personalized offer or multiple personalized offers. The email note may include a single merchant or list multiple merchants. The consumer receives the individualized merchant list and individualized offers, as shown in block 214, and the consumer makes a selection, as shown in block 216. The flow of actions continues based on the user selection. The flow of actions mat continue at blocks 226 or 230 as described above depending on whether the consumer selects an offer or a merchant specified in the email note body. In addition, the consumer may select a link to the personalized coupon system initial page such that the flow of actions continues at block 218, or the consumer may select a link to a merchant category such that the flow of actions continues at block 222.

The personalized coupon system enables advertising service providers, merchants and retailers to provide an offer to individuals, namely consumers and prospective consumers of merchants and retailers. The term merchant advertiser is used herein to refer to any service provider, retailer, or merchant that participated in the personalized coupon system described herein. The offers are based on the consumer's past behavior of viewing, clicking, obtaining or printing and redeeming offers, as well as the interrelation of these behaviors and non-actions, and the geographic location of the consumer. As used herein, non-action, includes, when on a web page or via email or other communication, a consumer takes one action and not a subsequent action, such as viewing a merchant's advertisement and then not clicking on an offer, or clicking on an offer and then not obtaining it or printing it, or printing or obtaining an offer and then not redeeming it.

As set forth herein, the individualized offers based on behavior may be delivered via email, gadget, widget, cellular phone application, Internet web pages, really simple syndication (RSS), SMS or other text message, instant messaging, cellular/text, Variable Digital Print for mail, or other delivery system that individually identifies the consumer. These offers may be sent as and referred to as personalized electronic messages. An example individualized offer email note body 300 is provided in FIG. 3. In this example, the individualized offer email note body 300 includes individualized offer sections under both the headings “Your Offers” 310 and “Recent Interests” 320. The individualized offers under the heading the heading “Your Offers” 310 include offers based on the activity, in-activity and geographic location of the user, and may include offers similar to but not the same as viewed or used other offers. The individualized offers under the heading “Recent Interests” 320 includes offers based on the activity and geographic location of the user, and may include offers from and similar to viewed or used other offers. In addition, the email note may contain offers that were popular among similarly situated other users shown as “Popular Picks” 330. The email note may also contain offers from merchants who are new to the personalized coupon system shown as “New Merchants” 340. The system may select the popular picks and new merchants presented in the email note based on the consumer's activity history, the date a merchant advertiser was added to the system, and the geographic location of the consumer and merchant advertiser. The email note may be HTML based with email headers such as to, from, and date, and footers such as a signature block containing identifying and contact information of the coupon system provider, not shown.

An example individualized offer web page 400 is shown in FIG. 4. In this example, the individualized offer web page 400 includes merchants and offers based on the geographic location of the consumer and merchant advertisers arranged in groups, namely “featured merchants” 410, “eat & drink” 420 and “health & beauty” 430.

Consumers can redeem the offer provided or delivered to them at the merchant advertiser's physical (and, in some cases, virtual) storefronts. Consumers can redeem the offer at a storefront using a printed version of the coupon or an electronic version of the coupon available on the consumer's cell phone, mobile computer or other portable computing device.

In one embodiment, hard copies of coupons received from consumers may be stored by the merchant and collected from the merchant by the personalized coupon system provider. In another embodiment, the merchant may scan a bar code, QR code or other code from the coupon using a handheld scanner device such as, for example, an Adesso NuScan scanner coupled to a merchant's personal computer, a scanner coupled with a point of sale system, or the merchant may use a cell phone that includes a camera and scanning software. In this embodiment, upon scanning the coupon, information about the purchase or other activity is transmitted from the merchant to the personalized coupon system server over the Internet or other network. This transmission may be performed immediately or at regular intervals that may be merchant customizable.

The personalized coupon system may pass certain information, namely consumer ID, Merchant ID, Offer ID and date of offer deliver, securely within a code and/or UPC barcode with the offer, which allows the system to track redemption of the offer and initiate a follow up thank you communication that includes one or more links to currently available offers for the particular consumer and associated merchant. Tracking consumer behavior within the personalized coupon system for particular offers, such as take rate and non-take rate (that is, the number of people who view and/or click on the offer, but do not print or redeem it), provides propriety data that is valuable for crafting offers that have an improved response rate.

The tracking described herein, and in particular in blocks 224, 228, 232, 236 and 244 of FIG. 2, is performed by the system storing tracking information, including the consumer ID, an associated action or behavior code, and a time and date of the occurrence of the action. More specific information may be included in the tracking information, such as the specific offer viewed, obtained, printed or redeemed, or the kind of offer viewed, obtained, printed or redeemed. Additional information may also be stored as part of the tracking information, including a web page view time, the time from email distribution to web site visit resulting from an email link traversal, and others. The system may store the tracking information in a database included as part of the personalized coupon system.

Now that an overview of the personalized coupons system has been provided, components within the personalized coupon system are described. The components described herein describe functionality and features as separate entities. However, a personalized coupon system may include some or all of these components. These components may be implemented independently, may be implemented with other subcomponents, may be implemented as a single program, or may be implemented with overlapping features or features arranged differently.

A. Special Offer Optimization Component Having Behavior Based Progressive and Regressive Offer Features

The personalized coupon system obtains and stores sets of offers and business rules specific for each merchant advertiser. The business rules are used by the system to determine which offer will be presented to an individual consumer and how the consumer will progress through or regress through the offer set based on the application of a combination of the business rules with the consumer's behavior. For example, a restaurant may have an offer set (series of offers) as follows:
Offer #1: Buy one entrée get one free (approximate savings=50%)
Offer #2: Buy one entrée get one half price (approximate savings=25%)
Offer #3: Buy one entrée get a free side (approximate savings=15%)
Offer #4: Free appetizer for party of four (approximate savings=10%)
Offer #5: Free beverage with purchase of two entrées (approximate savings 5%)

According to this example, offer #1 is available and delivered electronically to all consumers. The system tracks consumers using one or more techniques, including through consumer registration with the system web site, cookies stored through the consumer's web browser, the consumer's IP address, and redemption codes. The system tracks registered and anonymous consumer activity with the personalized coupon system, including the following behavior events: when an offer is viewed, clicked, printed (or similarly delivered such as delivery of coupon to cell phone via SMS text or other messaging technique) and redeemed in store or online. Based on the business rule to advance after the behavior event of printing a first time, the system functions so that after a consumer prints offer #1, the system advances/progresses to the next offer for that particular consumer from that merchant advertiser to display or deliver offer #2 from that merchant advertiser to that particular consumer. In this scenario, the system makes offer #1 no longer available to this consumer. The system progresses through the remainder of the offers in similar fashion, replacing the current offer with the next offer. Example business rules include the following.

Example Rule Type: Progression. This kind of rule defines when the system progresses to the next offer in an merchant advertiser's set of offers for the particular consumer after the current offer has been printed by the consumer, after the current offer has been viewed by the consumer, or after some other action has been taken by the consumer. The behavior of a “print” and the “number of times” the behavior occurs is tracked before the business rule progresses to the next offer in merchant advertiser's set of offers. The system tracks the behavior and corresponding time as set-up for or by merchant advertisers in the system. In one example, a business rule for the merchant advertiser's offer set may be “printed” “three times” before progressing immediately to next offer. Similarly, in another example, the rule may specify that when an offer is “viewed” or “clicked” “two times”, the current offer is removed and the system advances or progresses to the next offer in the offer set from the merchant advertiser for that particular consumer. In another example rule, a merchant advertiser could specify that a current offer may be “viewed” and/or “clicked” and/or “printed” for “two months” before the system removes the current offer, progresses to the next offer from that merchant advertiser for that user and replace the current offer with the next offer. The business rules may also be varied between offers such that different rules apply to different offers. For example, the rule for offer #1 may be for the system to progress to the next offer after one consumer printing of the current offer and the rule for offer #2 may be for the system to progress to the next offer after two prints of the current offer.

Referring now to FIG. 5, according to a progression rule, after a consumer views or prints an offer 524a from a particular merchant, when the consumer visits the web page 500 on a future visit, the system will display an updated web page with offer 524b and a new offer 524c (not shown) from the offer set for the particular merchant based on the consumer's tracked activity history and the system applied progression rule for the merchant.

Referring now to FIG. 6, according to a progression rule, after a consumer views or prints an offer 624a from a particular merchant, when the consumer visits the web page 600 on a future visit, the system will display an updated web page with offers 624b, 624c and a new offer 624d (not shown) from the offer set for the particular merchant based on the consumer's tracked activity history and the system applied progression rule for the merchant.

Example Rule Type: Regression. This kind of rule defines when the system regresses to a previous offer in a particular merchant advertiser's set of offers after the current offer has not been printed by the consumer over a defined period of time, after the current offer has not been clicked on or tapped by the consumer after a defined period of time, or after some other action has not been taken by the consumer. The time periods may be merchant advertiser defined and/or system defined. An example time period is two weeks from the last printing of an offer by a particular consumer for the merchant advertiser. This is an example of application of a business rule for non-behavior, in this case “not printing” for a period of time, such as, for example, one week, two weeks, one month, etc. While the system may automatically progress through an offer set based on a consumer action such as printing or other offer delivery according to a progression rule, the system may also automatically regress based on business rules. In this example, the system can be set to automatically regress to a previous offer in an offer set when a current offer has not been used for some period of time, such as, for example, since the last offer was printed by or delivered for a particular consumer. So if regression is turned on for the offer set example above (in addition to the business rule of progression immediately on print) and is set for the behavior of non-printing for 60 days, if a user prints offer #1 and then prints offer #2 within 60 days, and then offer #3 within 60 days, but does not print offer #4 within sixty days from when offer #3 was printed, the system will regress to make the previous offer (offer #3) available electronically for printing or similar delivery.

The election of regression may be configurable and/or customizable though a user interface the system provides to merchant advertisers. Regression may be turned on and customized by each merchant advertiser. Regression may be turned off by a merchant advertiser. When regression is turned off by a merchant advertiser, offers will not regress to a previous offer in the offer set. In one embodiment, the last offer in an offer set for a merchant advertiser will be static and always available when regression is turned off. The system may allow merchant advertisers to set regression business rules to regress only one offer per user and then either remain static on that offer or progress according to other business rules. The rule may be stored on storage media included in or coupled with a server that executes software that implements the system.

The personalized coupon system may enable a merchant advertiser to set or specify a period of time that an offer will remain valid. This may be achieved via a system provided merchant advertiser dashboard or data entry screen on the system web site which is described further below. The period of time may be a set date or may be based on the date the consumer viewed the offer. For example, the offer may be valid until a specified date such as, for example, Jul. 31, 2009. For example, the offer may be valid until a specified number of days or weeks since last or initial view of the offer by the consumer or since the offer was printed by the consumer or otherwise delivered to the consumer. In one implementation, the system allows a merchant advertiser to specify a validity period of from 1-90 days from the date the offer is printed or otherwise delivered. The use of a validity period helps prevent abuse of valuable offers by enabling them to only be valid for shorter periods of time, such as, for example, 2 or 3 days from when the offer is printed or otherwise delivered. The kind of offer period and the length of the offer period may be merchant customizable, selectable and/or configurable for each offer within a set of offers.

When the system presents an offer to a consumer, it may securely convey the following offer information: (a) consumer ID, (b) merchant ID, (c) offer ID, and (d) date printed or obtained. Additional information may also be included in the offer information, such as, for example, expiration date and human readable offer information such as the name of the merchant, location of the merchant, hours of operation of the merchant, accepted payment types, and restrictions on the offer, such as not available on weekends. The offer information may be provided in printed offers via UPC barcode, QR codes and other codes.

FIG. 7 is a screen shot of a window that includes a printable coupon 700. The printable coupon 700 includes the name of the merchant or a graphic that includes the name of the merchant 710, a text description of the offer 720, such as, for example, buy one get one free and $10 off a purchase of $30, restrictions on the offer, such as an expiration date and not available on weekends, a map showing the location of the merchant 750, location of the merchant 752, hours of operation of the merchant 754 and phone number 756, and may also include accepted payment types. A barcode 730 or other scanable element is provided on the printable coupon 700. The barcode or other code may be a unique tracking code that allows the system to identify and associate the offer redemption with a particular consumer.

With a portable device, the offer may be conveyed via passing of a viewable or scanable tracking code to a mobile phone or portable wireless device. The tracking code ties back to a server side tracking of that code to the information above, or may be an electronic barcode or other code. In another embodiment, the offer may include a redemption button, slider, or other user interface item that allows a user or merchant to notify or signal the system that the offer was redeemed. In a related embodiment, a merchant advertiser may provide or enter a merchant redemption code for the consumer to communicate back to the system upon offer redemption. The redemption code may be entered into a web page, email note, SMS text message or other communications technique that allows for sending to the system.

So that the personalized coupon system may provide consumers with personalized coupons for a merchant advertiser, personalized coupon system allows the merchant advertisers to specify information about themselves and the offers to be provided to consumers. The system provides an interface that allows merchant advertisers the ability to specify offer information and business rules into a database on the personalized coupon system. In one embodiment, the personalized coupon system server provides a dashboard or other data entry web pages that allow a merchant advertiser to specify general information about the merchant advertiser including uploading logos and/or other images, the terms and conditions of the offers, and how the merchant advertiser's offers and related web pages, email notes and other communications will be presented, delivered or displayed to consumers.

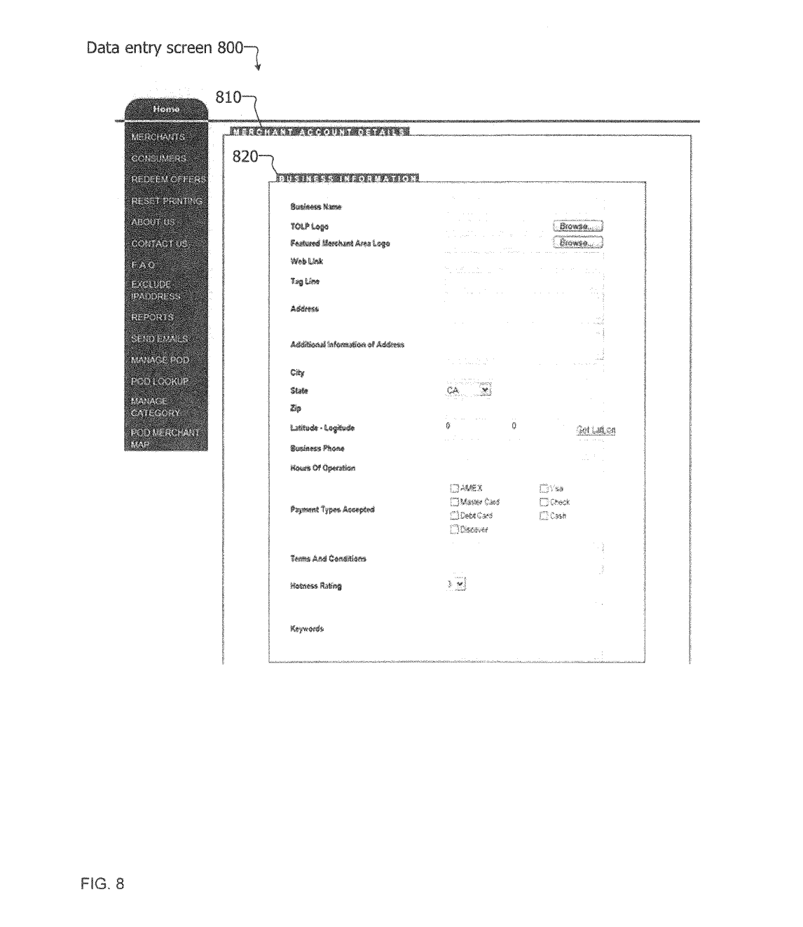

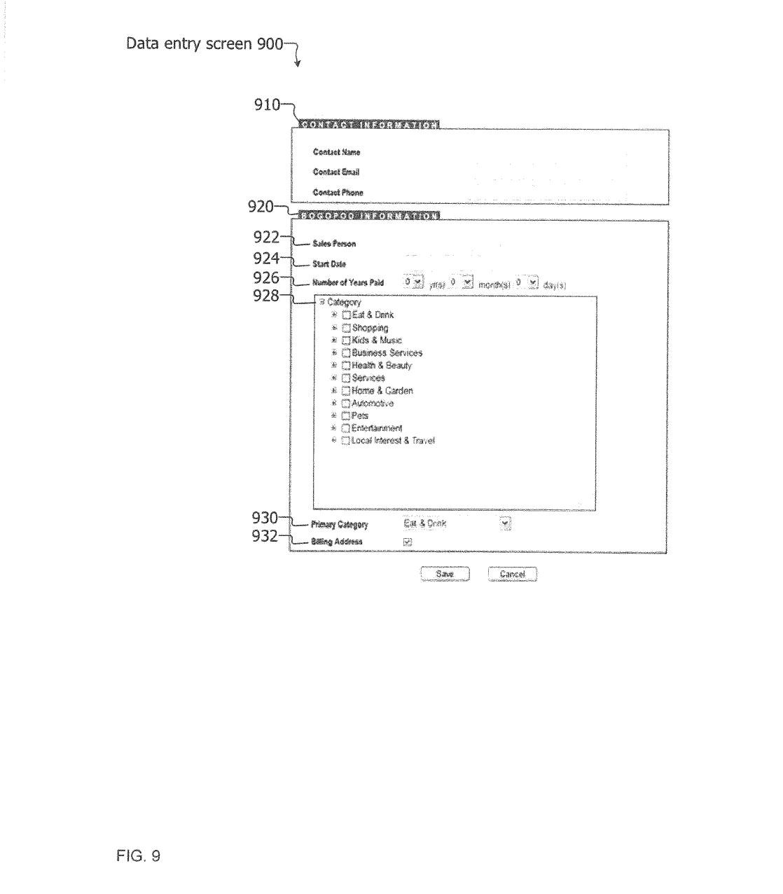

FIGS. 8 and 9 are screen shots of portions of merchant data entry screens. The data entry screen portions 800 and 900 allow, depending on the implementation, merchant advertisers or a system operator to specify merchant account details 810 including business information 820, merchant advertiser contact information 910 and system specific information 920. The fields provided to and available in FIGS. 8 and 9 vary depending on whether the merchant data entry screens are provided to a system operator or a merchant advertiser. In one embodiment, merchant data is provided by merchant advertisers to a system operator over the phone, by email and/or by filling out paper forms. The system operator may then use the merchant data entry screen in FIGS. 8 and 9 to enter merchant data. In another embodiment, the merchant advertisers may provide the merchant data to the system via the merchant data entry screens.

The system may store business information referred to as merchant data such as the name of the business, a logo for the business, web page or other web link, a tag line, address information, phone number for the business, and kinds of payments accepted including specific credit cards. The merchant data may also include a designation or specification of an area or region served. The area or region served may be received by selection of system provided check boxes, pull down menus and/or text entry fields. The area or region served may be designated by area code, zip code, town name, city name, region name, area name, and others. In addition, the business information stored as merchant data by the system may include special terms and conditions for the business, keywords applicable to the merchant advertiser. When the merchant data entry screen is provided for access only for a system operator, a hotness rating may be provided as part of the business information. The hotness rating may be a numerical or other score or scale that reflects a priority or preferred placement and/or propensity of placements of the merchant in relation to other merchants. For example, hotness may be designated on a one to ten scale or an A, B, C, D, E, F scale where A and one are the hottest businesses given the best placement and/or are more often placed on web pages and in email notes or other communications, and F and 10 are the least hot or coldest merchant advertisers, and will receive less desirable location and/or less frequent placement in web pages, email notes and other communications. Other preferred, prioritization or propensity scales may be used to display the merchant advertiser and/or offers from the merchant advertiser.

Contact information 910 provided as part of the merchant information 810 may include a contact name, contact email address and a contact phone number for the merchant advertiser. The contact information may specify a person at a merchant advertiser that the provider of the personalized coupon system should contact with any questions or issues regarding offers provided by the merchant advertiser or any billing issues. The contact information may specify a person at a merchant advertiser that consumers should contact with any questions or issues regarding offers provided by the merchant advertiser.

Merchant account details 810 may also include system specific information 920. The system specific information 920 may include the name of a sales person 922 at the personalized coupon system that retained the merchant advertiser, a start date 924 of the merchant advertiser's registration with the personalized coupon system, a number of years the merchant advertiser has a paid subscription 926 to the personalized coupon system, a selection of business categories 928 describing the kind of good and/or services provided by the merchant advertiser, a primary business category 930 for the merchant advertiser and a billing address for the merchant advertiser 932.

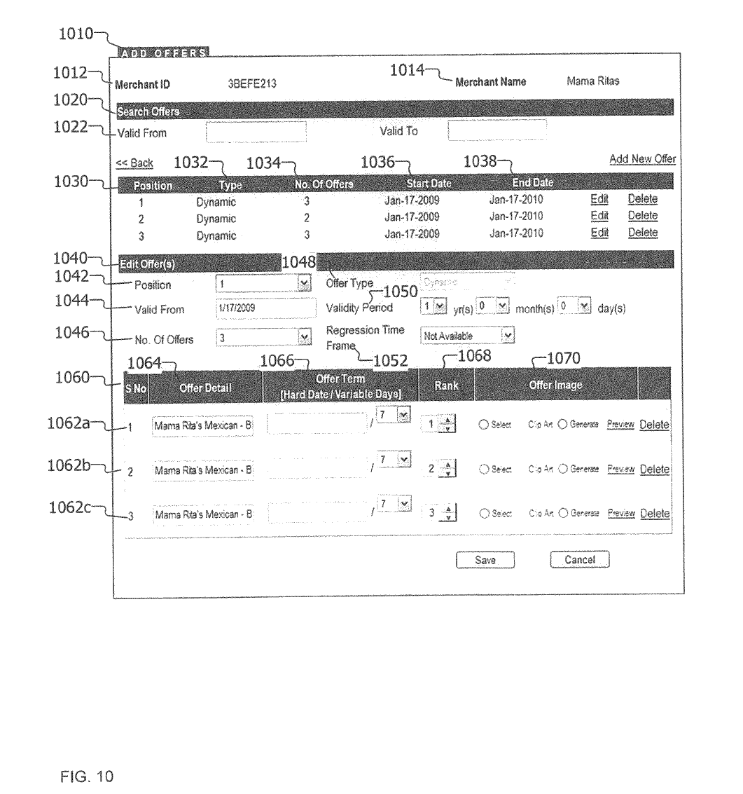

For the system to provide offers to consumers, the system provides an interface in the form of an offer specification web page that allows merchant advertisers and/or system operators to specify information needed to present an offer. FIG. 10 is a screen shot of a portion of a web page that includes an offer data entry screen. The fields provided to and available in FIG. 10 vary depending on whether the offer data entry screen is provided to a system operator or a merchant advertiser. In one embodiment, offer data is provided by merchant advertisers to a system operator over the phone, by email and/or by filling out paper forms. The system operator may then use the offer data entry screen 1010 to enter offer data into the system. In another embodiment, the merchant advertisers may enter the offer data directly into the system via the offer data entry screen 1010.

The add offer data entry screen 1010 may include pre-populated fields specifying the merchant ID 1012 and merchant name 1014. The merchant name 1014 is part of the merchant advertiser's business information 820 shown and described regarding FIG. 8, and the merchant ID 1012 may be a system created alpha-numeric string that uniquely identifies the merchant advertiser. As used herein, various identifiers, including Merchant IDs, Offer IDs and Consumer IDs may each be a unique combination of alphanumeric characters, that may include or be an IP address, a phone number, a street address, or other unique combination of alphanumeric characters.

A search offers heading 1020 designates an area that the system allows a merchant advertiser to search earlier created offers based on specified criteria. The search may be based on the validity dates 1022 of the offers. This search is helpful to merchant advertisers as a new offer may be based on an earlier presented offer.

The offer specification page allows a user to view, edit and delete current offers. The interface shows information about offers including the position 1030 of the offer, the type of offer 1032, the number of offers 1034, the start date of the offer 1036, and the end date of the offer 1038. When an offer is selected, information about the offer may be edited under the edit offer heading 1040. When editing an offer, some or all of the following information about the offer may be specified: the position of the offer 1042, the validity start date 1044 and validity period 1050, the number of offers 1046, the offer type 1048, and the regression time frame 1052. The number of offers 1046 and the regression time frame 1052 may be used to specify a set of offers that perform according to a progression and/or regression rule describe herein. The number of offers 1046 designates the number of offers in a set of offers, and the regression time frame 1052 may be used to specify the amount of time before regressing from one offer to another offer in the set of offers.

In addition, the sequence of the offers in a set may be specified in column 1060. The sequence number 1062a, 1062b, 1062c (or other similar order designator) is used in implementing the progressive and regressive offer rules described herein. In this example, the offer having sequence number 1 (1062a) is provided before the offer having sequence number 2 (1062b) which is provided before the offer having sequence number 3 (1062c). The number of offers in a set may be system set or may be system customizable. For example, some merchants may provide three offers (as shown) other merchants may provide one offer, two offer, five offers, eight offers, etc. In designating the sequence of offers in a set, the offers are selected by viewing or specifying text offer detailed information 1064, an offer term 1066 is specified, a rank 1068 for each of the offers is specified, and an offer image 1070 used in or associated with the offer may be selected from clip art, already uploaded images, may be generated. In addition, the system may allow the user to preview, edit and delete the offer image.

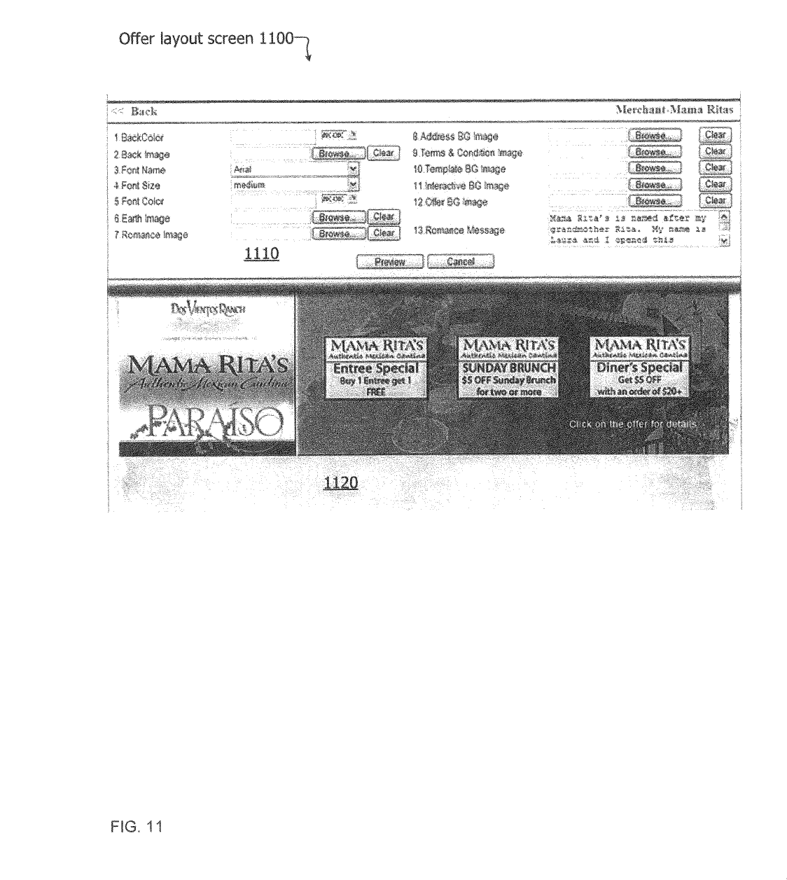

FIG. 11 is a screen shot of a portion of a web page that includes an offer layout screen 1100. The fields provided to and available in FIG. 11 vary depending on whether the offer layout screen is provided to a system operator or a merchant advertiser. In one embodiment, offer layout specification information and files are provided by merchant advertisers to a system operator over the phone, by email and/or by filling out paper forms. The system operator may then use the offer layout screen 1100 to specify the offer layout using the system. In another embodiment, the merchant advertisers may specify and upload the layout information and files directly into the system via the offer data entry screen 1100.

The offer layout screen 1100 may be described as having two areas, a specification pane 1110 and a preview pane 1120. The specification pane allows a merchant advertiser to specify how an offer will look while the preview pane 1120 shows the result of the selections made in the specification pane 1110. The specification may allow the user to specify various characteristics and features about the look of an offer, such as, for example, background color, background image, font type, font size, font color, kind of image, an address background, a terms and conditions image, a template background image, an interactive background image, an offer background image and a romance message. A “romance message” is text that describes the merchant advertiser in, for example, less than 80 words. The system allows for provision of this text, so that the test will be displayed as an alternative when graphics cannot be rendered. In addition, the romance message is provided so that the offer and/or merchant is identified by search engines which enables the offer to be included in Internet search engine search results and allow for search engine optimization.

The data entry and specification screens shown in FIGS. 8, 9, 10 and 11 may use various web page constructs to prompt for and obtain merchant advertiser information, offer information and layout information, including, for example, text entry fields, pull down menus, walking menus, buttons, sliders, radio buttons, check boxes and others.

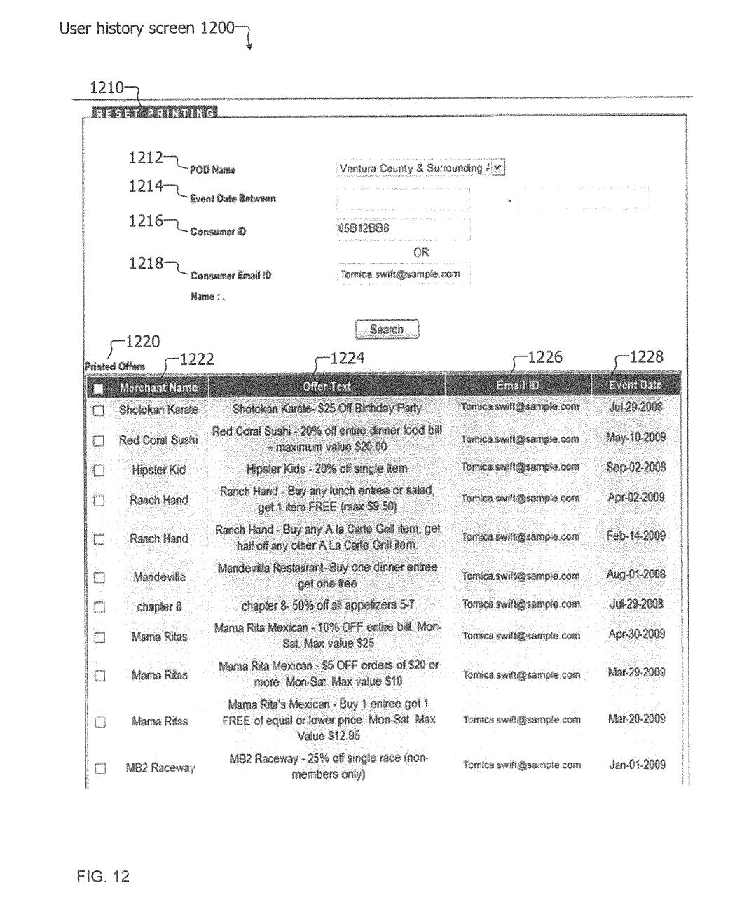

FIG. 12 is a screen shot of a portion of a web page that includes a user history screen 1200 of offers a particular consumer has viewed, printed and/or or redeemed. The system makes the user history screen 1200 available only to system operators. In one embodiment, consumers are identified within a database on the system's server via an alphanumeric consumer ID code 1216. Consumers may also be identified by their IP address, name, physical address, email address, phone number and other alphabetical, numeric or alphanumeric strings. To view the offers viewed, printed and/or redeemed by a consumer, the system operator specifies the consumer ID 1216 in a text entry box. Alternatively or additionally, the email address 1218 may be specified in a text entry box. The name of the user may be specified by the system operator or, in another embodiment, may be displayed by the system after the operator specifies the consumer ID and/or email address. The geographic area 1212 for the user may also be displayed or specified. The user history screen 1200 allows a system operator the ability to view offers a consumer has viewed, printed and/or redeemed. The list of offers may be provided in a table-like form showing the merchant name 1222, a text description of the offer 1224, an email identifier 1226 or email address or delivery address of the consumer, and the date the offer was viewed, printed or redeemed, shown as the event date 1228. A check box, pull down menu or other user interface construct may allow a system operator to select to view printed offers 1220, obtained offers, viewed offers, redeemed offers, or all offers accessed by the user in any way. Another column, not shown, may specify whether the offer was viewed, printed or redeemed.

In one embodiment, consumers are identified within a database on the system's server via an alphanumeric consumer ID code. The consumer ID ties together all personal information available on the consumer, such as: email address and/or IP address used to access system web site; first and last name; physical mailing address; where the user opted in along with the date and IP or where they signed up as a source; birth date; merchant advertisers viewed along with the offers clicked, printed and/or redeemed and the dates of those behaviors.

The system allows merchant advertisers to attract and retain new consumers and reinvigorate past consumers to become more loyal consumers again through offers and communications that will acquire consumers at lower costs than traditional media and also at an increasingly lower cost through the progression and regression of offers that is not available elsewhere. The system allows merchant advertisers to acquire the greatest number of consumers at the lowest optimal cost. The personalized coupon system recognizes that the cost of consumer acquisition differs for different individuals based on varying factors that influence buying decisions, such as, for example, taste, proximity, budget, time, etc. The system customizes offers presented to consumers based on a particular consumer's behavior. The personalized coupon system does not use a predictive algorithm to predict anticipated consumer behavior. The personalized coupon system provides a behavior based algorithm for each merchant advertiser that is calculated based on consumer behavior and driven by the business rules that control how the system presents offers. The personalized coupon system provides offers to consumers based on the consumer's own demand curve or predilections for the particular business product or service.

Additionally, the system tracks the consumer take rate and non-take rate of offers. The system prepares quantifiable data on individual offers based on take rate tracking. The system uses this data to refine offers and offer sets. This results in an improved impact of the offers so that the desired number of consumers at the appropriate margin for the business is attracted. The system also has cost and efficiency benefits over traditional media, including less paper waste providing for eco-friendly marketing.

From a consumer perspective the system provides numerous benefits. Key benefits include the continuous availability of offers, the ease of access to offers, and the superior offers available. Rather than having to cut out and save a coupon, or remember a web address, with the system's combination of email and web site (and other electronic delivery methods), consumers can access offers any time by going to their email box using their computer or a portable computing device and linking from the email to the related web site to print or save offers; or consumers can go directly to the web site to print or save the offers at any time. Also, since merchant advertisers provide a progression of offers, merchant advertisers are willing to make offers continuously available, recognizing that the merchant advertisers will not likely experience the abuse of having a costly offers repeatedly redeemed. Additionally, since this advertising by participating in the personalized coupon system is more cost effective and since progressive offers are used, merchant advertisers often provide more favorable offers to attract consumers than they would elsewhere without the control of that progressive offers allows. Thus, the consumer obtains better offers.

The personalized coupon system is different from other offer systems in a number of ways. Other offer systems: have static offers that do not change based on individual behavior; do not economically deliver individualized offers en masse; do not track behavior and response to an offer at the individual level (some do not even have a way to track behavior and response at the gross level); do not deliver individual offers en masse, based on the individuals past behavior and related business rules; do not track and report non-take rates for improvement and refinement of offers; do not both progress and regress through offers based on user behavior and business rules; and do not instantly change offers and their availability.

These factors provide advantages over existing offer systems, such as direct mail, newspapers, yellow pages, search engines, key word ad systems (pay-per-click and other related models), and other online coupon sites. Since these other systems provide the same offer to all users, a merchant advertiser is stuck with giving potential discounts to existing consumers (regulars) that would have purchased without the offer. For example, if a business provides a “buy one get one free” offer to attractive new consumers and uses direct mail to send the offer to all households in their zip code (standard practice for direct mails systems such as ValPak, MoneyMailer, MoneyClipper, etc.), the same offer is delivered to all households. Typically, these systems will mail monthly or every six weeks, so when the next one is mailed with the same offer, or even with a different offer, there is no way to track who used the first offer, to provide them a different offer, while still providing their best offer to only consumers who did not use the first offer. Thus, businesses typically are faced with the dilemma of promoting their most attractive (and costly on a margin perspective) offer to attract trial from new consumers, and having regulars using the offer when they would have likely come in without it or if they were provided a lower cost/margin offer. Indeed, the regulars become trained to find these offers and probably use them at a higher rate than new consumers, hurting the businesses margin every time they send out the offers. Similarly online, offers presented to users are static and do not differentiate based on past user behavior.

B. Email Generation Component—Periodic Cooperative Email with Individualized Offers

The cooperative email component of the personalized coupon system combines and presents multiple offers and businesses across categories into a single email using company names, logos and offers that are customized for the recipient consumer based on the consumer's individual behavior, the consumer's community's behavior (based on “hotness” factor) and the newest businesses who have recently joined the program that are geographically located in their community. The email is sent on a regular basis, such as, for example, every other week, so that the email and the offers are on the top of the minds of consumers. The frequency of email notes may be varied based on system provided frequencies and/or may be customizable. FIG. 3 provides an example email note. The email format provides a consistent experience for all participating merchant advertisers and their offers, making it easy for the consumer to understand and navigate the offers.

Cooperative email may be implemented using template methodology including specialized tags within the template to retrieve the information stored in a data table or database maintained by the personalized coupon system. The data table is populated with information from the personalized coupon system through an application programming interface (API) to enable customized presentation of visual and textual information, as well as associated deep web links, to a user based on their preferences and past behavior. This template methodology provides for the massive personalization of messaging and related links. The template uses HTML formatting as well as other graphic representation technology to present the information to the user. The template has over 200 fields of information that are updated by the personalization integration component described below, whenever the API is executed. The fields of information include data for the file location of the graphic file associated with merchants and their offers, text copy describing merchant offers, and the associated deep links into the integrated web site for a particular merchant and offers available to that particular user. Along with those fields, a unique identifying field is incorporated with the deep web links to communicate with the system to further personalize their experience. The appropriate graphic, text and link information are based on the user region/geography and the user behavior as provided via the personalization integration component. The cooperative email template captures the data for each user within the email sending platform and seamlessly compiles and presents the information individualized for the consumer within each email sent.

There are several benefits of the cooperative email component to both consumers and merchant advertisers. From the consumer perspective, benefits of the cooperative email component include: [1] Receiving a single email message that includes multiple relevant offers, instead of being bombarded with multiple email messages from individual businesses which clutter their email boxes; [2] Receiving a formatted email that easily allows the consumer to understand that the email is about offers to save money and other promotions, what categories and businesses are included; and how to easily access the offers, without having to go through a learning curve for each separate email from separate businesses; [3] Time savings and entertainment value provided from the content of the cooperative email. Similar to the reasons why people browse shopping malls and why car dealers locate in groups near one another to ease shopping, comparison and purchase decision making, the cooperative email and integrated personalized coupon system web site provide similar consumer values.

Benefits of the cooperative email component to merchant advertisers include having their company name welcomed and viewed by consumers on a regular basis. Consumers are more apt to accept and review a periodic email on a more frequent basis when it includes a variety of offers, instead of one predictable email that comes from one business. So, for example, consumers will open email messages on a more regular basis that they know includes multiple offers from a growing and changing number of businesses to see what is new, than they will open a regular email messages soliciting the same product or service from a single business, for example from a pest control company, dry cleaner or any other single product or service provider. There is power and value in the presentation of an aggregation of offers from multiple merchant advertisers.

Another benefit of the cooperative email component to merchant advertisers is that businesses receive incidental tangential exposure to consumers when a consumer views the co-operative email for a separate specific reason or category of interest and sees nearby listings and offers for other categories of business. For example, a consumer may be looking at restaurants and see offers for rain gutter repairs, which the consumer had no specific reason for viewing at the time. But when rainy season comes and the consumer's gutters overflow, the consumer will remember that the consumer can get offers for gutters via the cooperative email and its related integrated web site.

Another benefit of the cooperative email component to merchant advertisers is that an email message including a merchant advertiser's offer being viewed by consumers enables businesses to remain top of mind, which is valuable to the business and will result in increased sales and/or new consumers.

The cooperative email component differs from existing systems in a number of ways that present significant competitive advantages. Other email marketing systems include offers from either individual businesses or at best a category of business in email messages. As such, these other email marketing systems do not train the consumer to expect more, and soon the emails from these systems become predictable, less interesting and less valuable to the consumer. Individual email messages are more costly in terms of the actual cost related to sending the email message. For example, there is a higher cost to send separate emails to 100,000 consumers for ten different businesses, than to send one email message to 100,000 consumers that cooperatively include the 10 separate businesses. And the cooperative email system reduces the clutter caused by multiple separate email message in a consumer's inbox.

Since the email sent by the cooperative email component is customized for the consumer based on the consumer's behavior, the email message highlights the businesses that the consumers have either used before and/or those businesses that are located geographically closest to them. When a consumer clicks and/or prints and uses an offer from a particular merchant advertiser, that merchant advertiser is highlighted for them within the consumer's individualized email. In this way, the email message provides the service of reminding the consumer of what merchant advertisers they have considered and/or used or visited previously. Additionally, the email highlights the merchant advertisers in the consumer's geographical area that are most popular, based on the behavior of consumers for that geographical area. This makes consumers aware of offers that the consumer may not have discovered otherwise.

C. Personalization Integration Component

The personalized coupon system may include a personalization integration component. The personalization integration component allows for customizing and integrating email messages with related web sites and user behavior on that web site. The personalization integration component includes application programming interface integration with email service providers (ESPs); a dynamic content email template; and data for massive personalization and integration with the web sites and/or personalized coupon system.

The personalization integration component integrates a user's behavior as it is captured via actions taken by the consumer when visiting to the personalized coupon system web site, and when viewing personalized offers received by email. The personalization integration component creates direct links from the email messages deep into the personalized coupon web site to access those individualized offers without the requirements of registering, logging in or navigating through preliminary web pages.

The personalization integration component may be integrated in the personalized coupon system web site and may connect to one or more offer delivery systems, including cell phone, AVR, variable digital printing presses, etc. and others. The personalization integration component tracks each consumer's behavior including offers viewed, clicked on, tapped on or otherwise selected or activated, printed and redeemed. The personalization integration component captures the time at which and the time frame between which these actions are taken. With this information about the behavior for consumers, the personalization integration component creates a file that may be integrated with an application programming interface to be uploaded into an email system or email service provider, so that with the accompanying template used within the email system, the file can be read to generate a unique email message for each recipient based on the consumer's past behavior. Additionally, the email template with the information from the file creates deep links into the web site (or other offer delivery system) to allow the email recipient to link directly to the offer customized for the consumer without having to log in, register, or navigate through preliminary web pages. The personalization integration component achieves this by providing specific electronic information that relates to the visual, textual, locational (in terms of file name, IP address, server, etc.) information of the specific offer as part of the email note or other communication represented in an HTML, text based or other format that can be handled by a consumer's receiving email or other offer delivery system. The following is an example record layout of a record communicated via personalization integration component to an email system.
POD Territory/geography(s) the consumer has as their area(s) of interest for merchant offers and promotions
CUSTID The Consumer ID is used to uniquely identify each User
EMAIL Email used to send out the template
FIRSTNAME Used to personalize each message
LASTNAME Used to personalize each message
SOURCE Identifies the source where the user came from allowing for better targeting
DINING1 First merchant to be displayed graphically in the DINING Category
DINING1LINK The Deep Web Link associated with the merchant in the DINING 1 field
DINING1TEXT The description of the offer from the merchant associated with the DINING1 field. Can be used as alt information for graphical representations
DINING2 Second merchant to be displayed graphically in the DINING Category
DINING2LINK The Deep Web Link associated with the merchant in the DINING2 field
DINING2TEXT The description of the offer from the merchant associated with the DINING2 field. Can be used as alt information for graphical representations
SHOPPING1 First merchant to be displayed graphically in the SHOPPING Category
SHOPPING 1LINK The Deep Web Link associated with the merchant in the SHOPPING 1 field
SHOPPING 1TEXT The description of the offer from the merchant associated with the SHOPPING 1 field.
   Can be used as alt information for graphical representations

The personalization integration component may also provide the individual user's identifier within the link, so that the user does not have to log in, register or navigate to the page deeper within the site for the personal offer.

Referring to the example record layout above, within the template, there may be calls to the data table instead of hard coded actions to create personalized messages for the user. For example, the first graphic and link may look like:

<a href=”http://www.bogopod.com/%%
DINING1LINK%%?CID=%%CUSTID%%”><img
src=”%%DINING1%%”
width=”150” height=”90” border=”0”
alt=”%%DINING1TEXT%%”></a>

The data field called DINING1LINK exists within the link above. The link starts with the URL and since all the links are going to the same URL, that part is hard coded within the template. The individualized information, which has been provided from personalized coupon system, is displayed after the URL in the form of %% DINING1LINK %%. The DINING1LINK consists of all the information needed to complete the lookup of the specific merchant and the specific offer. The “?CID=” code is present to signify the additional personal information related to the Consumers ID. Finally the link is completed with the %% CUSTID %% to identify the user. The image is within the image tag in the form of %% DINING1%%. The alt tag is used to further explain the offer and merchant in the form of %% DINING1TEXT %%.

The template is not limited to only using “%%” before and after the field names. These tags may be requirements from the Email Service Provider (ESP). These tags can take different forms and formats to achieve the goals described herein, including, for example, double percent signs, double question marks, and other combinations specified by the individual ESP.

The personalization integration component enables massive personalization of email messaging based on individual behavior and business rules within the personalized coupon system. The personalization integration component may link the personalized coupon system to an email or other offer delivery system.

There are no current offerings with which to compare the personalization integration component included as part of a personalized coupon system. Current broadcast media offerings do not customize offerings based on progressive/regressive offer systems and therefore the need for this does not exist outside of the personalized coupon system. The personalization integration component differs from direct mail/database marketing systems which customize offers, but they are typically based on demographic information or product purchase information and does not involve progressive/regressive offers for the same merchant advertiser and their product/service to the same user over time.

D. Behavior Mapping and Reporting Component

The behavior mapping and reporting component provides individual merchant advertisers with map and table reports that visually indicate the different behavior of consumers across time and geography. This allows merchant advertisers to understand and see the geographical location of consumers that view, click, print and redeem offers over a time period. Similarly, the behavior map reporting component illustrates those geographic areas where merchant advertisers are not reaching or are not converting consumers into buyers of products or services.

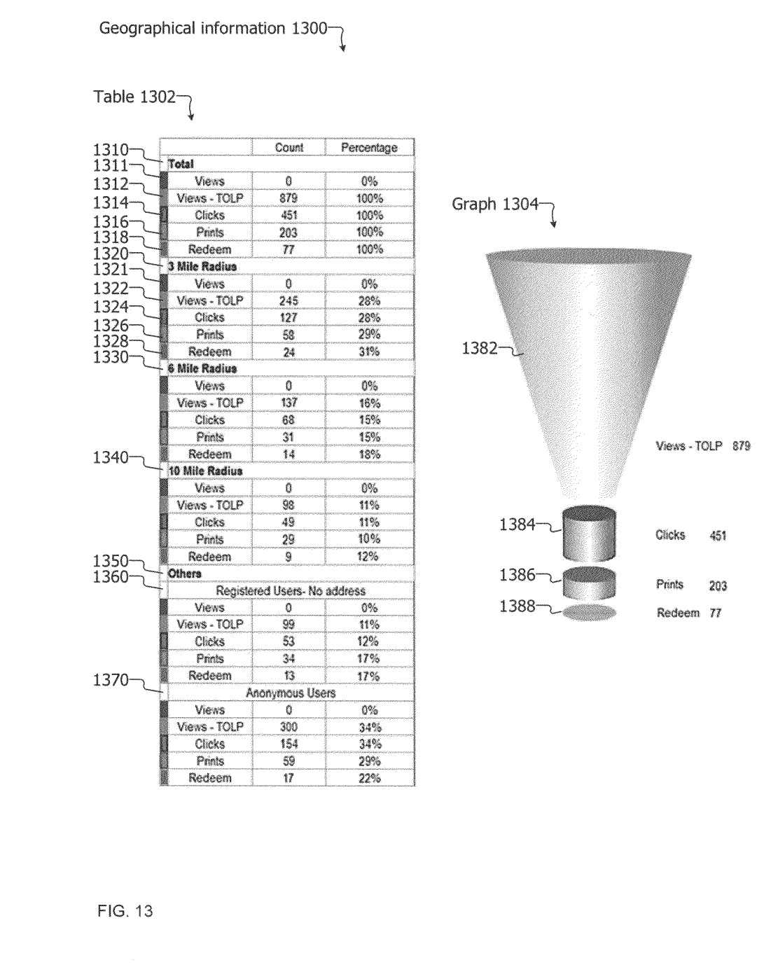

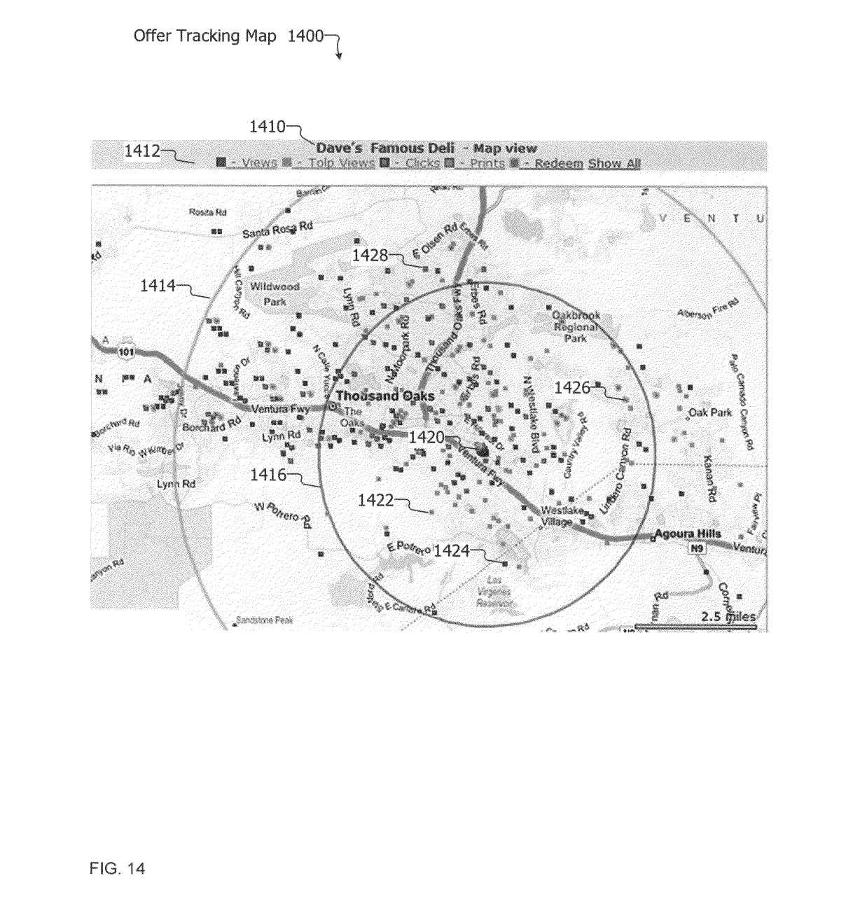

The behavior map reporting component may provide a behavior map report that includes two portions, the geographic location of coupon users and an offer tracking map. FIG. 13 is a screen shot of a portion of a web page that includes information and a graph of geographical locations of coupon users for a merchant, and FIG. 14 is a screen shot of a portion of a web page that includes an offer tracking map 1400. The information and graphics shown in FIGS. 13 and 14 may be included in a single web page to a merchant advertiser, may be provided as a PDF document or other computer file by email or by download to a merchant advertiser, or may be printed on paper and sent by traditional mail to a merchant advertiser.

To create the behavior map report, the system uses information stored regarding the behavior of consumers maintained by the system as it relates to each merchant advertiser. To achieve this, the system stores information about consumer behaviors, such as, for example, whether and when the consumer viewed, clicked, printed, and redeemed an offer. The time that the consumer took these actions is also stored.

Referring to FIG. 13, geographical information 1300 about consumer usage of offers may be provided in a table 1302 and related graph 1304. The report may provide data on the number of consumers that have exhibited certain behaviors within a certain mile radius of the business over a particular time period. Behaviors within, for example, three, six, ten and greater than 10 miles are shown in table 1302. Table 1302 also shows the number and the percentage of the total consumers that performed certain activities and their registered location distance from the merchant advertiser's place of business. The mile radius may be system defined, merchant advertiser selectable and/or merchant advertiser customizable. The time period may be a system default time period, may be system operator specified or may be merchant specified.

As shown in table 1302, the total number 1310 of consumers that viewed 1312, clicked on 1314, printed 1316, and redeemed 1318 an offer from a merchant advertiser are listed and associated with a particular color, such as, for example, orange, blue purple and green. Similarly, the number of consumers within a three mile radius 1320 that viewed 1322, clicked on 1324, printed 1326, and redeemed 1328 an offer from a merchant advertiser are listed and associated with a particular color. This information is also provided for consumers with a registered address within a six mile radius 1330 and 10 mile radius 1340 of the merchant advertiser, as well as for other consumers 1350, such as consumers out of the regions displayed, consumers that registered without providing an address 1360, and anonymous consumers 1370.

The corresponding graph 1304 provides a readily appreciable representation of the ratio of total consumer views of an offer 1382 in orange, the total number of consumers that clicked on, tapped on or otherwise activated a link associated with the offer 1384 in blue, the total number of consumers that printed the offer 1386 in purple, and the total number of consumers that redeemed 1388 the offer in green. The colors used in the graph 1304 correspond to the colors used in the table 1302. The system may provide a similar graphical representation of information about consumer activity for consumers within certain geographic radii of the merchant advertiser in response to a merchant advertiser clicking on, tapping or otherwise activating a link associated with the respective three mile radius heading 1320, six mile radius heading 1330, 10 mile radius heading 1340, and others heading 1350. The system redraws the graph 1304 in response to a user clicking on the headings 1310, 1320, 1330, 1340 and 1350.

Referring now to FIG. 14, to create the offer tracking map 1400, the system uses information stored regarding the behavior of consumers maintained by the system as it relates to one or more offers from a merchant advertiser to plot color coded dots representing consumer behavior on a map. To achieve this, the system accesses information about consumer behaviors, such as whether the consumer viewed, clicked, printed, and redeemed an offer. When preparing the offer tracking map, the system may use consumer address information to identify latitude and longitude to plot the dots. The system may filter the activity of consumers based on time periods, which may be merchant advertiser selectable, configurable and/or customizable. The offer tracking map 1400 may specify the name of the merchant advertiser and provide 1412 a key to information provided in the offer tracking map 1400. The offer tracking map 1400 may display radii that correspond to the geographical information 1302 and graph 1304 shown in FIG. 13. The offer tracking map 1400 may display radius boundary 1414 representing six miles from the merchant advertiser and radius boundary 1416 representing three miles from the merchant advertiser. The offer tracking map 1400 may display different, additional and fewer radius boundaries. The offer tracking map 1400 may display radius boundaries that do not correspond to the radii provided in the geographical information 1302 and graph 1304 shown in FIG. 13. The merchant advertiser may be shown with a special, distinguishable graphical representation such as a yellow star, black square 1420 or other graphical representation.

The system may display color coded dots, pins or other graphical representation of the various actions taken by consumers regarding the merchant advertiser 1410 in the offer tracking map 1400. The offer tracking map 1400 may present color coded dots, pins or other graphical representation of the various actions taken by consumers regarding the merchant advertiser 1410 in colors that correspond to the colors used in the geographical information 1302 and graph 1304 shown in FIG. 13, or the colors used may be different and independent of the geographical information 1302 and graph 1304 shown in FIG. 13. As shown, the orange squares 1422 represent consumers that viewed an offer from the merchant advertiser; the blue squares 1424 represent consumers that clicked on tapped, or otherwise activated a link associated with an offer from the merchant advertiser; the purple squares 1428 represent those consumers that printed an offer from the merchant advertiser and the green squares 1426 represent consumers that redeemed an other from the merchant advertiser.

The behavior map report component of the system allows merchant advertisers to see in which geographical areas the merchant advertisers are reaching consumers, and in which geographical areas the merchant advertisers are not reaching or converting consumers. Merchant advertisers may use this information for subsequent marketing activities, such as direct marketing to consumers in certain geographic areas with additional or different offers, identifying additional prospective consumer locations to target, identifying new/better locations for the merchant advertiser to locate, and tracking the success of marketing over time.

The system's reporting on consumers' views, clicks, prints and redemptions enables businesses to readily see and evaluate the effectiveness of marketing with actual (not surveyed) data. The system locates and represents graphically with maps and tables where consumers are located. The behavior mapping and reporting component may provide anonymous peer group data by processing data regarding and providing reports regarding all merchants in a merchant advertiser specified region or a merchant advertiser specified category of merchants. The system may provide an user interface that allows a merchant advertiser to select regions and categories of merchants from pull down menus, by text entry boxes, and by other web page techniques.

E. Consumer Loyalty Component

The consumer loyalty component provides the operator of the personalized offer system the ability to offer merchant advertisers to use their online and offline interactions with consumers to build a valuable database for ongoing communication by providing special offers from one or more merchant advertisers in a single convenient email note in return for joining a loyalty club powered by the personalized coupon system. The consumer loyalty component provides a turn-key system to merchants that also provides a benefit to the consumer for joining. The consumer loyalty component provides ongoing benefits to the consumers of the merchant advertisers. Additionally, as consumers use the offers, the redeemed offers are collected and recorded into the personalized coupon system database and integrated with other stored data to generate a personalized coupon system branded loyalty “thank you” communication via email, or other message delivery system, with a link to more offers that are customized for the consumer based on the consumer's behavior.

The operator of the personalized coupon system may provide merchant advertisers with signage, forms and collection boxes and bowls to communicate to their consumers in person the benefits of joining, that is, registering with, the personalized coupon system. When a consumer provides certain information, which may include some or all of: name, address, zip code, email address, cell phone number, home phone number, and birth day and month, the personalized coupon system enters the information into its database with a tags for the merchant advertiser where the consumer signed up, along with the date entered into the system. This information is collected by the consumer completing a form or otherwise giving the information, such as, for example, by providing a business card. This may also be achieved by the user entering information at a computer terminal or electronic kiosk at the participating merchant's location. The loyalty component of the personalized coupon system may automatically generate a welcome email message to the consumer from the merchant advertiser with the branding, logo, message of both the merchant advertiser and the operator of the personalized coupon system. The welcome message may include a link to the merchant advertiser's web page on the personalized coupon system web site and/or offer links from the personalized coupon system. The welcome message may also provide the consumer with a text explanation of the reason why the consumer is receiving the email message; an unsubscribe link; and the physical address of the merchant advertiser.

Now the consumer is entered into personalized coupon system and will receive cooperative email messages generated by the personalized coupon system. The personalized coupon system may also allow the merchant advertiser to send email messages en masse or by triggers (for example, birthday offers) to the consumers in the database having a tag or other entry signifying that the consumer became a participant in the personalized coupon system through the particular merchant advertiser. When the consumer redeems a customized offer from the merchant advertiser, the merchant advertiser may track the consumer using the offer via the unique tracking code provided as part of the personalized coupon system. When a redeemed offer is entered into the personalized coupon system, the personalized coupon system may generate a loyalty building “thank you” email message from the merchant advertiser to the consumer, with a link to more customized offers from the merchant advertiser.

The consumer loyalty component provides merchant advertisers that do not have an extensive database of consumers and prospects or a consumer relationship management (CRM) system with an effective, reliable and easy way to develop their database and communications with consumers and prospects. The consumer loyalty component allows merchant advertisers the ability to establish a relationship with a consumer in person, and provide offers online. The customer loyalty component enables businesses to provide consumers the ability receive offers in an email message that includes multiple merchants advertisers. The customer loyalty component provides a welcome email message and an immediate link so that the consumer may receive offers from the merchant advertiser.

Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. A computer comprising a processor, a memory, a communications device, and a storage medium, the storage medium having software stored thereon, the software including instructions which when executed by the processor cause computer to perform actions, including:
receiving and storing merchant data from a plurality of merchants
receiving and storing offer data from the plurality of merchants
providing a localized web page to a consumer based on a location of the consumer, the initial localized web page including at least one of a merchant list and an offer list, the merchant list including merchants located near the location of the consumer and the offer list including offers from merchants located near the location of the consumer, the offer list based on the offer data and the merchant list based on the merchant data
receiving a consumer selection of a selected merchant or a selected offer from the offer list or the merchant list in the localized web page
providing an offer web page to the consumer, the offer web page including at least one offer based on the selected merchant or the selected offer
receiving a consumer selection to print a first offer as a printed first offer, the printed first offer including a tracking code, offer details and merchant information for an offering merchant
providing an updated offer web page to the consumer, the updated offer web page excluding the first offer and including a second offer from the offering merchant based on a progression rule and stored activity information for the consumer.

2. The computer of claim 1 wherein the software includes further instructions which when executed by the processor cause the computer to perform further actions comprising:
receiving offer redemption information from a merchant after the consumer has redeemed the printed first offer with the offering merchant.

3. The computer of claim 1 wherein the software includes further instructions which when executed by the processor cause the computer to perform further actions comprising:
providing a second updated offer web page to the consumer, the second updated offer web page including the first offer after both the first offer had previously been provided and the second offer was provided based on a regression rule.

4. The computer of claim 1 wherein the software includes further instructions which when executed by the processor cause the computer to perform further actions comprising:
providing a second updated offer web page to the consumer, the second updated offer web page including the first offer after a time period since the second offer was provided and either the first offer was not redeemed by the consumer or the second offer was not printed by the consumer.

5. The computer of claim 1 wherein the location information is determined from consumer input specifying a location.

6. The computer of claim 1 wherein the location information is determined from one of the consumer's IP address or consumer registration information.

7. The computer of claim 6 wherein the registration information includes at least one of a consumer phone number, a consumer city, an email address and a consumer zip code.

8. The computer of claim 1 wherein the tracking code is one of a bar code, QR code, or unique alphanumeric string.

9. The computer of claim 1 wherein the software includes further instructions which when executed by the processor cause the computer to perform further actions comprising:
when the consumer selects a merchant,
receiving consumer selection of a selected merchant from the merchant list
tracking consumer merchant selection of the selected merchant
when the consumer selects an offer from the offer list,
receiving consumer selection of a selected offer from the offer list
tracking consumer offer selection of the selected offer
when the consumer prints the selected offer,
receiving consumer selection to print the selected offer
tracking consumer offer printing of the selected offer
when the consumer redeems the selected offer,
receiving consumer redemption information of a redeemed offer from the offering merchant
tracking consumer offer redemption of the redeemed offer.

10. The computer of claim 9 wherein the software includes further instructions which when executed by the processor cause the computer to perform further actions comprising:
preparing and sending a personalized electronic communication to a particular consumer, the personalized electronic communication including a personalized offer, the personalized offer determined based on consumer activity for the particular consumer including at least one selected from the group including merchant selection by the particular consumer, offer selection by the particular consumer, offer printing by the particular consumer, and offer redemption by the particular consumer.

11. The computer of claim 9 wherein the software includes further instructions which when executed by the processor cause the computer to perform further actions comprising:
preparing and sending a personalized electronic communication to a particular consumer, the personalized electronic communication including a personalized offer, the personalized offer determined based on the activities of other consumers having similar geography and demographic information to the particular consumer.

12. The computer of claim 9 wherein the software includes further instructions which when executed by the processor cause the computer to perform further actions comprising:
preparing and sending a personalized electronic communication to a particular consumer, the personalized electronic communication including a personalized offer, the personalized offer determined based on consumer activity of other consumers including at least one selected from the group including merchant selection, offer selection, offer printing, and offer redemption for other consumers.

13. The computer of claim 10 wherein the personalized electronic communication is selected from the group including an email note, a cellular telephone application communication, a text message, a multimedia message, an application window, and a text alert.

14. The computer of claim 11 wherein the personalized electronic communication is selected from the group including an email note, a cellular telephone application communication, a text message, a multimedia message, an application window, and a text alert.

15. The computer of claim 12 wherein the personalized electronic communication is selected from the group including an email note, a cellular telephone application communication, a text message, a multimedia message, an application window, and a text alert.

16. The computer of claim 9 wherein the merchants included in the merchant list and the offers included in the offer list in the localized web page are determined further based on activity of the consumer including at least one selected from the group including merchant selection, offer selection, offer viewing, offer printing, and offer redemption.

17. The computer of claim 9 wherein the merchants included in the merchant list and the offers included in the offer list in the localized web page are determined further based on the activities of other consumers having similar geography and demographic information to the particular consumer.

18. The computer of claim 9 wherein the merchants included in the merchant list and the offers included in the offer list in the localized web page are determined further based consumer activity of other consumers including at least one selected from the group including merchant selection, offer selection, offer viewing, offer printing, and offer redemption for other consumers.

19. The computer of claim 9 wherein the software includes further instructions which when executed by the processor cause the computer to perform further actions comprising:
preparing a behavior report including a geographic proximity of various consumers and an activity performed by the consumers for a specific merchant or a specific offer over a specified or default time period
providing the behavior report to the merchant.

20. The computer of claim 19 wherein the behavior report includes a table arranged according to the geographic proximity of various consumers to the merchant and the activity performed by the consumers, the activity including selected offers, viewed offers, printed offers and redeemed offers for the time period.

21. The computer of claim 19 wherein the behavior report includes a map including multiple radii of the geographic proximity of consumers to the merchant and color coded markers for the activity performed by the consumer, the activity including selected offers, viewed offers, printed offers and redeemed offers for the time period.

22. The computer of claim 19 wherein the providing the behavior report is achieved by one selected from the group including electronic mail, web access by electronic file download, or by postal mail.

23. A computer comprising a processor, a memory, a communications device, and a storage medium, the storage medium having software stored thereon, the software including instructions which when executed by the processor cause computer to perform actions including:
receiving and storing merchant data from a plurality of merchants
receiving and storing offer data from the plurality of merchants
providing over a network an offer list to a particular consumer based on a location of the particular consumer, the offer list including offers from merchants located near the location of the particular consumer
receiving over the network consumer selection of selected offers from the offer list for a plurality of consumers
tracking over the network consumer selection of the selected offers for the plurality of consumers as a plurality of viewed offers
receiving over the network selection from multiple consumers to obtain viewed offers as redeemable offers, the redeemable offers including a tracking code
tracking consumers obtaining redeemable offers
receiving offer redemption information from merchants of redeemed offers when consumers redeem redeemable offers
tracking consumer redemption of redeemable offers based on the redemption information
providing over the network an updated offer list to the particular consumer after the particular consumer has taken action regarding a first offer from a first merchant, the updated offer list excluding the first offer and including a second offer from the first merchant based on a progression rule for the first merchant.

24. The computer of claim 23 wherein the software includes further instructions which when executed by the processor cause the computer to perform further actions comprising:
preparing a behavior report including a geographic proximity of various consumers and an activity performed by the consumers for a specific merchant or a specific offer over a specified or default time period
providing the behavior report to the merchant.

25. The computer of claim 24 wherein the behavior report includes a table arranged according to the geographic proximity of various consumers to the merchant and the activity performed by the consumers, the activity including selected offers, viewed offers, obtained offers and redeemed offers for the time period.

26. The computer of claim 25 wherein the behavior report includes a map including multiple radii of the geographic proximity of consumers to the merchant and color coded markers for the activity performed by the consumer, the activity including selected offers, viewed offers, obtained offers and redeemed offers for the time period.

27. The computer of claim 25 wherein the providing the behavior report is achieved by one selected from the group including electronic mail, web access, by electronic file download, or by postal mail.

28. The computer of claim 23 wherein the registration information includes at least one of a consumer phone number, a consumer city, an email address and a consumer zip code.

29. The computer of claim 23 wherein the tracking code is one of a bar code, QR code, unique alphanumeric string.

30. The computer of claim 23 wherein the offers included in the offer list are determined further based on activities performed by the particular consumer including viewed offers, obtained offers and redeemed offers for the particular consumer.

31. The computer of claim 23 wherein the offers included in the offer list are determined further based on the activities of other consumers having similar geography and/or demographic information to the particular consumer.

32. The computer of claim 23 wherein the location information is determined from consumer input specifying a location.

33. The computer of claim 23 wherein the location information is determined from one of the consumer's IP address or consumer registration information.

34. The computer of claim 33 wherein the registration information includes at least one of a consumer phone number, a consumer city, email address, and a consumer zip code.

35. The computer of claim 23 wherein the tracking code is one of a bar code, QR code, or unique alphanumeric string.

36. The computer of claim 23 wherein the software includes further instructions which when executed by the processor cause the computer to perform further actions comprising:
providing a second updated offer list to the particular consumer based on a regression rule, the second updated offer list including the first offer after both the first offer had previously been provided and the second offer was provided in the updated offer list.

37. The computer of claim 23 wherein the software includes further instructions which when executed by the processor cause the computer to perform further actions comprising:
providing a second updated offer list to the particular consumer, the second updated offer list including the first offer after a time period since the second offer was provided and either the first offer was not redeemed by the consumer or the second offer was not obtained by the consumer.

38. The computer of claim 23 wherein the redeemable offers include offer details and merchant information for an offering merchant.

39. The computer of claim 23 wherein the providing the offer list is achieved by providing one of a web page, a text listing, a cellular telephone application communication, a text message, an email note, an application window, or a text box.
